(19) United States
(12) Patent Application Publication
(10) Pub. No.: US 2026/0102316 A1
(43) Pub. Date: Apr. 16, 2026

(54) Air Bubble Massage Mat and Air Bubble Massage System

(71) Applicant: TSAI-YING WU, NEW TAIPEI CITY (TW)

(72) Inventor: TSAI-YING WU, NEW TAIPEI CITY (TW)

(21) Appl. No.: 18/986,777

(22) Filed: Dec. 19, 2024

(30) Foreign Application Priority Data
Oct. 15, 2024 (TW) 113139115

(51) Int. Cl. A61H 33/02

(52) U.S. Cl. CPC A61H 33/025; A61H 2201/1238; A61H 2201/1654; A61H 2201/5056

(57) ABSTRACT

An air bubble massage mat is provided which includes a cushion cover having a top layer and a bottom layer, the top layer and the bottom layer are joined together to form an accommodation space therebetween, and the top layer and the bottom layer are a mesh cloth with grids respectively. An air bubble massage system using the air bubble massage mat is provided, the regulator is provided for controlling the air delivered by the air supply to enter the flexible tubes through the delivery pipe, the control valve assembly, the gas channels, and the gas through holes to generate the first bubbles through the blowholes on the wall of the flexible tubes, and then the first bubbles is cut into the second bubbles through the grids of the top layer of the cushion cover, in which the size of first bubbles is larger than that of the second bubbles.

### CROSS-REFERENCE TO RELATED APPLICATIONS

This application claims the benefit of TW113139115, filed Oct. 15, 2024, which is incorporated in its entirety by reference herein.

### FIELD OF THE INVENTION

The present invention relates to a massage mat, particularly relates to an air bubble massage mat and air bubble message system, which is used to place in a bathing device, the air bubble is generated in the water through the air delivered by the air supply device pass through the staggered grids of the top layer of the mat to cut the bubbles into dense bubbles to product a massage effect on the user.

### BACKGROUND OF THE INVENTION

Modern people have busy lives and high work pressure, and rarely have time to exercise and leisure every day. Insufficient exercise is one of the major reasons why people are unhealthy today. As people's attention to their own health continues to increase, a variety of spa machines or spa devices have been launched on the market, the people can go back home to take a message bath to relax, so the stress of the day after a busy day can be released.

In response to the trend of the times and people's demand for life quality, the bubble bath machine or spa bathmats have become a tool that people choose to relax and release stress. In the prior art, the air bubble bath machine is mainly composed of an air generating device and a bubble cushion. The air generating device is connected to the bubble cushion. The air is discharged from the plurality of air holes on the bubble cushion, so there are many tiny bubbles generated in the bathtub filled with water, and tiny bubbles exert a message effect on the user. In another prior art, a hydrotherapy pad includes a forming pad and far-infrared ceramic balls. The far-infrared ceramic balls are arranged in matrix on an upper surface of the foaming pad, a ventilation tube is provided on the upper surface of the foaming pad, and a plurality of vent holes are provided on the wall of the ventilation tube. Although this hydrotherapy mat can generate large bubbles, the size and specification of the bubbles are not suitable for different sizes of the bathtub or bathing pools. It is inconvenient to carry and is prone to equipment damage and blockage of vent holes during storage or transportation.

In addition, in the prior art, the air delivered by the pump to the spa mat or bubble mat will have a slight heat loss. When the air enters the pipe fitting of the spa mat or bubble mat and is ejected from the air outlet of the pipe fitting, the temperature of the bubbles will be lower than the water temperature, so the bubble massage experience is not feeling well for user.

### SUMMARY OF THE INVENTION

According to drawback of the abovementioned prior art, the present invention provides an air bubble massage mat, the main object is to use the grids of the cushion cover to cut the bubbles generated by the air supply through the delivery pipe into dense bubbles, the dense bubbles is used to massage the user's whole body.

An object of the present invention is that when the air supply delivers air to the air bubble massage mat through the delivery pipe, the temperature of the bubbles generated in the water has a uniform temperature effect on the bubbles due to the presence of the cushion cover. In addition, the cushion cover is stacked by mesh cloth with different soft material and hard materials, and the mesh cloth with soft materials has permeability characteristics, which can even out the temperatures of bubbles and water. When the cushion cover is in a warm water environment, the cushion cover can retain the maximum human body temperature, so the cushion cover is capable of storing temperature. Furthermore, the cushion cover is also capable of delaying the time of lowering the local water temperature, so the local cooling rate in contact with the human body can be delayed, so the comfortable experience of bubble massage can be improved.

One object of the present invention is that the cushion cover of the air bubble massage mat is made of at least one layer of three-dimensional mesh cloth or a multi-layer of three-dimensional stacked mesh cloth. Under the warm water environment, the grids of the cushion cover can reduce the bubbles rising rate to lower the heat loss of the water temperature, so it doesn't need to add hot water multiple times to adjust the water temperature in the bathtub.

One object of the present invention is that the cushion cover of the air bubble massage mat can be folded to store, and is easy to clean, so as to extend the service life of the air bubble massage mat.

One object of the present invention is that an air bubble massage mat is composed of cushion cover and cushion body. The cushion cover is covered on the cushion body. When air enters the gas flow channels of the cushion body, and the bubbles generated through the plurality of air holes passes through the grids of the cushion cover to cut the bubbles into dense bubbles to increase the user's physical comfort experience during bubble massage.

According to above objects, the present invention provides an air bubble massage mat, the characterized is in that: a cushion cover includes a top layer and a bottom layer, in which the top layer and the bottom layer are joined together to form an accommodation space therebetween, in which the top layer and the bottom layer are a mesh cloth with grids respectively.

According to above objects, the present invention provide an air bubble massage system using the air bubble massage mat, the air bubble massage system includes the cushion cover, a gas channel assembly, a pipe assembly, and a control valve assembly, in which the cushion cover includes a top layer and a bottom layer, the top layer and the bottom layer are joined together form an accommodation space therebetween, and the top layer and the bottom layer are a mesh cloth with grids respectively; the gas channel assembly is disposed in the accommodation space, and the gas channel assembly includes a valve connection end, a plurality of gas channels, and a plurality of gas through holes, in which one end of the plurality of gas channels is connected to the valve connection end, another end of the plurality of gas channels is connected to the plurality of gas through holes; the pipe assembly is connected to the gas channel assembly and disposed in the accommodation space of the cushion cover, in which the pipe assembly includes a plurality of flexible tubes and a wall of each the plurality of flexible tubes includes a plurality of blowholes, and the plurality of blowholes is also arranged below the top layer of the cushion cover; and the control valve assembly includes a regulator, one end of the control valve assembly is connected to the valve connection end, another end of the control valve assembly is connected to the air supply through the delivery pipe, the regulator is provided for controlling the air delivered by the air supply to enter each the plurality of flexible tubes through the delivery pipe, the control valve assembly, the plurality of gas channels, and the plurality of gas through holes to generate a plurality of first bubbles through the plurality of blowholes on the wall of each the plurality of flexible tubes, and then the plurality of first bubbles is cut into a plurality of second bubbles through the grids of the top layer of the cushion cover, in which the size of the plurality of first bubbles is larger than that of the plurality of second bubbles.

The present invention further provides an air bubble massage mat, characterized in that: a cushion cover is a mesh cloth with grids, and sides of the cushion cover has a fixing strap.

The present invention also provides an air bubble massage system using the air bubble massage mat, the air bubble massage system includes: a cushion body, a gas channel assembly, and a control valve assembly, in which the cushion body includes a plurality of gas flow channels, and a plurality of air holes on each the plurality of gas fluid channels, the gas channel assembly is connected to the cushion body, the gas channel assembly includes a valve connection end, a plurality of gas channels and a plurality of gas through holes, in which one end of the plurality of gas channels is connected to the valve connection end, another end of the plurality of gas channels is connected to the plurality of gas through holes, so the gas channel assembly is communicated with the cushion body through the plurality of gas through holes; the cushion cover is disposed on the top surface of the cushion body, the cushion cover is a mesh cloth with grids, and two sides of the cushion cover has a fixing strap, the cushion cover is provided for fixing on the cushion body through the fixing strap, so the mesh cloth with the grids is disposed above the plurality of air holes; and the control valve assembly, one end of the control valve assembly is connected to the valve connection end, another end of the control valve assembly is connected to the air supply through the delivery pipe, a regulator of the control valve assembly is provided for controlling the air delivered by air supply enters the plurality of gas fluid channels of the cushion body through the delivery pipe, the control valve assembly, the plurality of gas channels, and the plurality of gas through holes to generate a plurality of first bubbles through the plurality of air holes on the plurality of gas fluid channels of the cushion body, and then the plurality of first bubbles is cut into a plurality of second bubbles through the grids of the cushion cover, whereby the size of each the plurality of first bubbles is larger than that of the plurality of second bubbles.

### BRIEF DESCRIPTION OF THE DRAWINGS

FIG. 1 is a schematic diagram showing an air bubble massage mat in accordance with the present invention disclosed herein;

FIG. 2 is a schematic structural diagram of a cushion cover with a single layer or multiple layers in accordance with the present invention disclosed herein;

FIG. 3 is a schematic diagram showing an embodiment of an air bubble massage system in accordance with the present invention disclosed herein;

FIG. 4 is a schematic diagram showing another embodiment of the cushion cover in accordance with the present invention disclosed herein;

FIG. 5 is schematic structural diagram showing another embodiment of an air bubble massage mat in accordance with the present invention disclosed herein; and

FIG. 6 is a schematic diagram showing another embodiment of ai air bubble massage system in accordance with the present invention disclosed herein.

### DETAILED DESCRIPTION OF THE PREFERRED EMBODIMENT

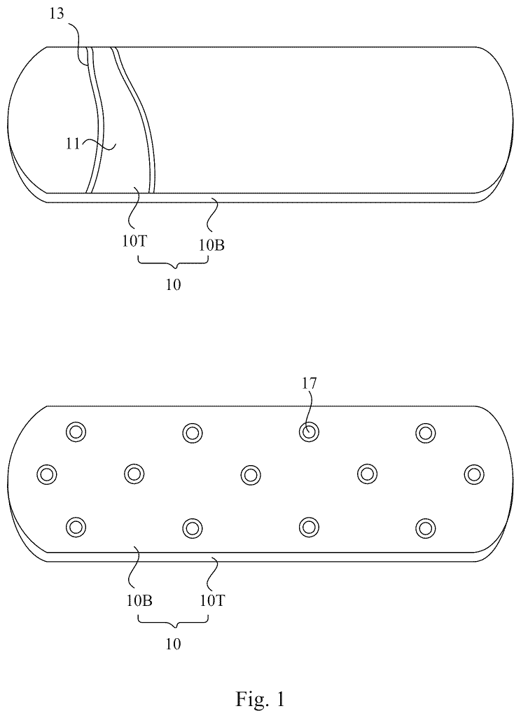

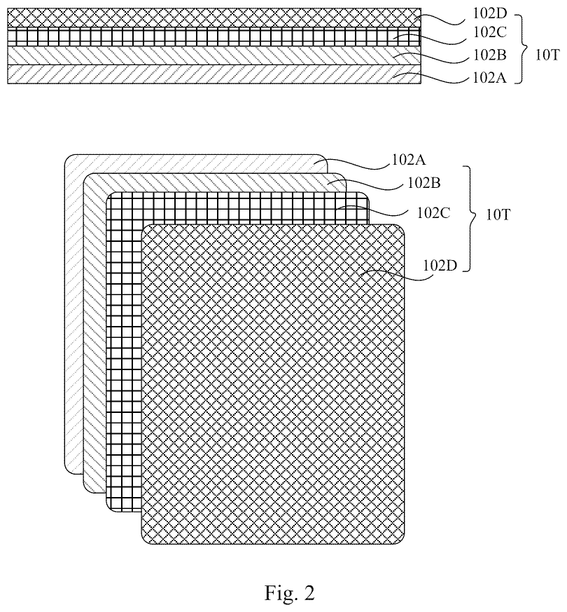

First, please refer to FIG. 1 and FIG. 2. FIG. 1 is a schematic diagram showing an air bubble massage mat and FIG. 2 is a schematic structural diagram of a cushion cover is a mesh cloth with grids. In FIG. 1, a cushion cover 10 includes a top layer 10T and a bottom layer 10B, the top layer 10T is joined to the bottom layer 10B to form an accommodation space 11 therebetween, and there is an opening 13 which is provided for accommodating the gas channel assembly (not shown) and a pipe assembly (not shown) in the accommodation space 11, that is, the gas channel assembly (not shown) and a pipe assembly (not shown) is disposed between the top layer 10T and the bottom layer 10B.

Next, as shown in FIG. 2, the top layer 10T and the bottom layer 10B of cushion cover 10 are a mesh cloth with grids respectively. Taking the top layer 10T as an example, the mesh cloth of the top layer 10T can be a single layer or a multi-layer. When the mesh cloth is a single layer, the grid shapes of the mesh cloth can be shown as mesh cloth 102C or mesh cloth 102D in FIG. 2. Moreover, when the mesh cloth is a multi-layer, the grid shapes of each layer in multi-layer can be shown as mesh cloth 102A, mesh cloth 102B, mesh cloth 102C and mesh cloth 102D in FIG. 2. Alternatively, the grid shapes can be arranged and stacked from two or three mesh cloth 102A, mesh cloth 102B, mesh cloth 102C and mesh cloth 102D in FIG. 2. It should be noted that the mesh cloth with different grid shapes, such as mesh cloth 102A and mesh cloth 102B are stacked, because the grids of mesh cloth 102A and the grids of mesh cloth 102B are interlaced each other, the air delivered by the air supply (not shown) to pass through the large bubbles generated by the pipe assembly (not shown), the large bubbles can be cut into dense bubbles through mesh cloth with different grid shapes. Due to the rising rate of dense bubbles in water is slower than that of the large bubbles, so the heat exchange time of bubbles in water is increased. If the air introduced is hot air, the drop rate of water temperature can be slowed down. In addition, in one embodiment, the mesh cloth constituting the cushion cover 10 has water-saturated characteristics, when the cushion cover 10 is placed in a warm water environment such as massage bathtub or bathtub, the water temperature in the massage bathtub or bathtub can be evened out by the cushion cover 10. Therefore, the cushion cover 10 can retain the maximum body temperature in the environment of warm water and has a temperature storage effect. In addition, cushion cover 10 is capable of delaying the time of lowering the local water temperature to achieve the delaying of local cooling rate in contact with the human body, and the comfortable experience of bubble massage can be improved.

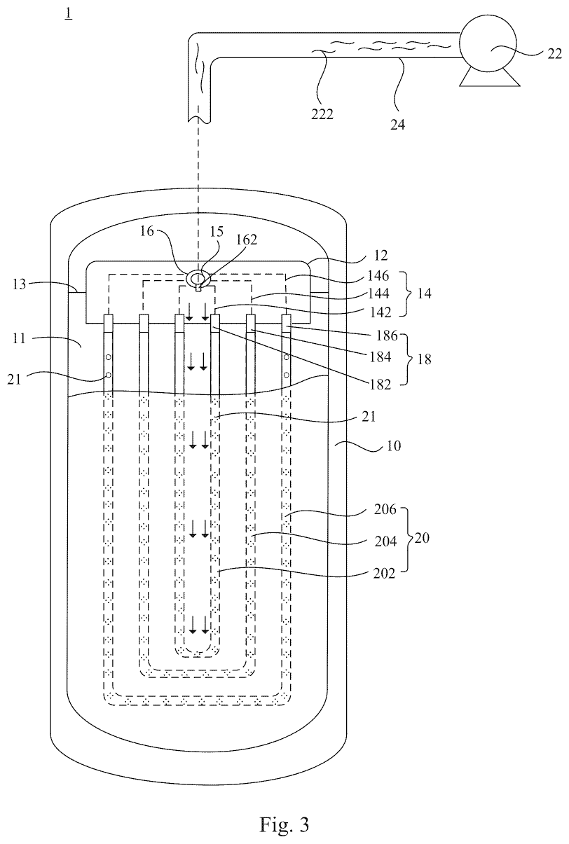

Please refer to FIG. 3. FIG. 3 is a schematic diagram showing an embodiment of an air bubble massage system. In FIG. 3, the air bubble massage system 1 includes a cushion cover 10, a gas channel assembly, 12, a pipe assembly 22, a control valve assembly 16, an air supply 30, and a delivery pipe 32, in which the cushion cover 10 is described as above, it is not further repeated herein.

The gas channels assembly 12 is disposed in the accommodation space 11 (as shown in FIG. 1) of the cushion cover 10, the gas channels assembly 12 includes valve connection end 15, a plurality of gas channels 14 and a plurality of gas through holes 18, in which one end of plurality of the gas channels 14 is connected to the valve connection end 15, another end of the plurality of gas channels 14 is connected to the plurality of gas through holes 18. The plurality of gas channels 14 includes an inner-side gas channel 142, a middle gas channel 144 and an outer-side gas channel 146. The plurality of gas through holes 18 also includes an inner-side gas through hole 182, a middle gas through hole 184 and an outer-side gas through hole 186, so the inner-side gas channel 142 is communicated with the inner-side gas through hole 182, the middle gas channel 144 is communicated with the middle gas through holes 184, and the outer-side gas channel 146 is communicated with the outer-side gas through holes 186.

The pipe assembly 20 is connected to the gas channel assembly 12 and is disposed in accommodation space 11 (as shown in FIG. 1) of cushion cover 10. The pipe assembly 20 includes a plurality of flexible tubes 202, 204, 206, and there is a plurality of blowholes 21 on a wall of each the plurality of flexible tubes 202, 204, 206, the plurality of blowholes 21 is disposed below the top layer 10T of the cushion cover 10. It should be noted that the flexible tube 202 is an inner-side flexible tube, the flexible tube 204 is a middle flexible tube, and the flexible tube 206 is an outer-side flexible tube, and two ends of the inner-side flexible tube 202 are connected to the inner-side gas through holes 182 respectively, two ends of the middle flexible tubes 204 are connected to the middle gas through holes 184, and two ends of outer side flexible tube 206 are connected to outer-side gas through holes 186, so the air 222 provided by air supply 22 enters the inner-side flexible tubes 202 (the direction of the arrow in FIG. 3) through the inner-side gas channel 142, inner-side gas through hole 182, the air flows from the inner-side flexible tube 202 to the end of the inner side flexible tube 202 and meets the air 222 of the inner-side gas through hole 182 through another end of the inner-side gas channel 142, the inner-side gas through hole 182 and the inner-side flexible tube 202. During the air flows, the air continuously generates a plurality of first bubbles from the plurality of blowholes 21 of the inner-side flexible tube 202 and is ejected to achieve a balance between the air intake and air ejection.

The control valve assembly 16 includes a regulator 162, one end of the control valve assembly 16 is connected to a valve connection end 15, another end of the control valve assembly 16 is connected to an air supply 22 through the delivery pipe 24. The regulator 162 is provided for controlling the air 222 delivered by air supply 22 passes through the delivery pipe 24, the control valve assembly 16, the plurality of gas channels 14, and the plurality of gas through holes 18 into the pipe assembly 20, so a plurality of first bubbles is generated through the plurality of blowholes 21 on the wall of each the plurality of flexible tubes 202, 204, 206, and the plurality of first bubbles is cut into a plurality of second bubbles through the grids of the top layer 10T of the cushion cover 10, in which the size of the plurality of second bubbles is smaller than that of the plurality of first bubbles.

In addition, in this invention, there are a plurality of suction devices 17 is further provided on the bottom layer 10B of the cushion cover 10 for fixing the air bubble massage mat includes the cushion cover 10, the plurality of gas channels 12 and the pipe assembly 20 in the massage bathtub (not shown) or bathtub (not shown), specifically, on the surface of the massage bathtub (not shown) or bathtub (not shown), and the surface of the massage bathtub or bathtub can be a smooth surface or a non-smooth surface, such as mosaic tile bathtub, thereby when the massage bathtub (not shown) or bathtub (not shown) filled with water, the air bubble massage mat with the cushion cover 10, the plurality of gas channels 12 and the pipe assembly 20 is placed in the massage bathtub (not shown) or bathtub (not shown) due to the buoyancy of water and the bubbles ejected through the plurality of blowholes 21 of the pipe assembly 20 to make the air bubble massage mat cannot be completely fixed on the surface of the massage bathtub (not shown) or bathtub (not shown), so the user cannot sit or lie down on the air bubble massage mat to enjoy a comfortable bathing environment.

According to the above-mentioned, an embodiment is given to illustrate, and also refer to FIG. 1 to FIG. 3 during the description. First, the air bubble massage mat includes the cushion cover 10, the gas channel assembly 12 and the pipe assembly 20 is connected to the air supply 22 through the delivery pipe 24, and the air bubble massage mat is fixed in the massage bathtub (not shown) or bathtub (not shown) through the suction device 17. After the user executes the air supply 22, the air 222 enters the control valve assembly 162 through the delivery pipe 24. At this time, the user can control the position of bubble generation through the regulator 162 of the control valve assembly. When the regulator 162 is at the first position, the air 222 will delivers through the inner-side gas channel 142 and the middle gas channel 144 of the gas channel 14 at the same time, and enter the inner-side gas through hole 182 and the middle gas through holes 184, so the air 222 can enter the inner-side flexible tube 202 and the middle flexible tube 204 at the same time. There is a plurality of first bubbles (not shown) will be generated when the air 222 passes through the plurality of blowholes 21 of the inner-side flexible tube 202 and the middle flexible tube 204. When the plurality of first bubbles (not shown) passes through the mesh cloth of the top layer 10T of cushion cover 10, the plurality of first bubbles (not shown) is cut into a plurality of second bubbles (not shown) by the grids of the mesh cloth of the top layer 10T, in which the size of each the plurality of second bubbles is smaller than that of each the plurality of first bubbles, thereby, the plurality of second bubbles is provided for massaging on the human body.

In another embodiment, when the user adjusts the regulator 162 at the second position, the air 222 will pass through the middle gas channel 144 and the outer-side gas channel 146 of the gas channel 14 at the same time, and enter the middle gas through hole 184 and the outer-side gas through hole 186, so the air 222 is allowed to enter the middle flexible tube 204 and the outer-side flexible tube 206 at the same time. When air 222 passes through the plurality of blowholes 21 of the middle flexible tube 204 and the outer-side flexible tube 20, a plurality of first bubbles (not shown) will be generated. Similarly, when the plurality of first bubbles passed through the grids of the mesh cloth of the top layer 10T of cushion cover 10, the plurality of first bubbles (not shown) is cut into a plurality of second bubbles (now shown), and the size of each the plurality of second bubbles is smaller than that of each the plurality of first bubbles, thereby, the plurality of second bubbles is provided for massaging the human body. In this embodiment, the bubbles area generated by the middle flexible tube 204 and the outer-side flexible tube 206 is larger than that of the inner-side flexible tube 204 and middle flexible tube 204, while increasing the massage area for user. It should be noted that the bubble area referred to here is the massage bathtub (not shown) or bathtub (not shown) occupied by the bubbles generated by the inner-side flexible tube 202 and the middle flexible tube 204, rather than the area of the bubbles themselves.

In another embodiment, when the user adjust the regulator 162 at the third position, the air 222 will enter the inner-side gas through hole 182, the middle gas through hole 184 and the outer-side gas through hole 186 through the inner-side gas channel 142, the middle gas channel 144, and the outer-side gas channel 146 at the same time, and enter the inner-side flexible tube 202, the middle flexible tube 204 and the outer-side flexible tube 206. When air 222 delivers through the plurality of blowholes 21 of the inner-side flexible tube 202, the middle flexible tube 204 and the outer-side flexible tube 206, a plurality of first bubbles (not shown) will be generated. Similarly, when the plurality of first bubbles (not shown) is passed through the top layer 10T of the cushion cover 10, the plurality of first bubbles (not shown) is cut into a plurality of second bubbles (not shown) by the grids of the mesh cloth of the top layer 10T of the cushion cover 10, and the size of each the plurality of second bubbles is smaller than that of each the plurality of first bubbles, thereby, the plurality of second bubbles is provided for massaging the human body. In this embodiment, the bubble area generated by the inner-side flexible tube 202, the middle flexible tube 204 and the outer-side flexible tube 206 is the largest and the user's entire body can be massaged. Similarly, the area referred to here is the massage bathtub (not shown) or bathtub (not shown) occupied by the bubbles generated by the inner-side flexible tube 202, the middle flexible tube 204 and the outer flexible tube 206, rather than the area of the bubbles themselves.

It should be noted that the design of the spacing between each the plurality of blowholes 21 on the inner-side flexible tube 202, the middle flexible tube 204, and the outer-side flexible tube 206 can be equal or unequal, in which the equality means that the spacing between each the plurality of blowholes 21 on the inner-side flexible tube 202, the middle flexible tube 204, and the outer-side flexible tube 206 is equal. Alternatively, the spacing between each the plurality of blowholes 21 on one single flexible tube is equal, but not equal to the spacing between each the plurality of blowholes on another flexible tube. In addition, unequal means that the spacing interval between each the plurality of blowholes 21 on one flexible tube is not equal and is also not equal to the spacing interval of each the plurality of blowholes 21 on another flexible tube. The advantage(s) of the spacing interval design of the blowholes 21 as above-mentioned is that since the leg(s) of human being is the most prone to fatigue which needs to massage, therefore, the spacing interval design of the plurality of blowholes 21 on the inner-side flexible 202, the middle flexible tube 204 and the outer-side flexible tube 206 of the pipe assembly 20 corresponding to the leg(s) of human being can be designed to be narrowed, so the user can adjust the region and amount of bubbles generated according to the three different regulating positions of regulator 162 of above-mentioned to massage the required body parts.

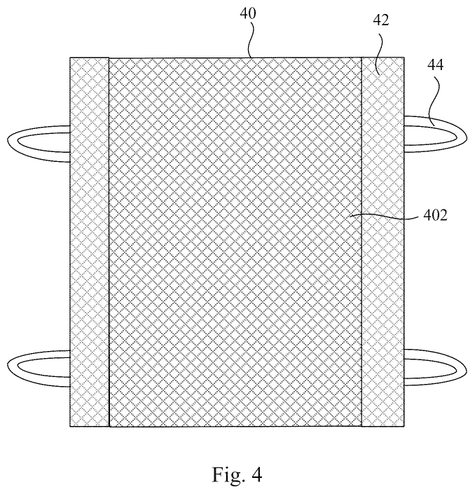

Next, please refer to FIG. 4. is a schematic diagram showing another embodiment of the cushion cover. In FIG. 4, the cushion cover 40 includes an upper surface 402 and a side surface 42 are a mesh cloth with grids, the mesh cloth can be a single layer or a multi-layer. When the mesh cloth structure is a multi-layer, the grid shapes of each layer in multi-layer can be shown as a mesh cloth 102A, a mesh cloth 102B, a mesh cloth 102C and a mesh cloth 102D in FIG. 2. Alternatively, the grid shapes can be arranged and stacked from two or three mesh cloth 102A, mesh cloth 102B, mesh cloth 102C and mesh cloth 102D in FIG. 2. It should be noted that the mesh cloth with different grid shapes, such as mesh cloth 102A and mesh cloth 102B, are stacked, because the grids of mesh cloth 102A and the grids of mesh cloth 102B are interlaced each other, the air 222 delivered by the air supply (not shown) to pass through the large bubbles generated by pipe assembly (not shown), the large bubbles can be cut into dense bubbles through mesh cloth with different grid shapes. Due to the rising rate of dense bubbles in water is slower than that of the large bubbles, so the heat exchange time of bubbles in water is increased. If air 222 introduced the delivery pipe 22 is hot air, the drop rate of water temperature can be slowed down.

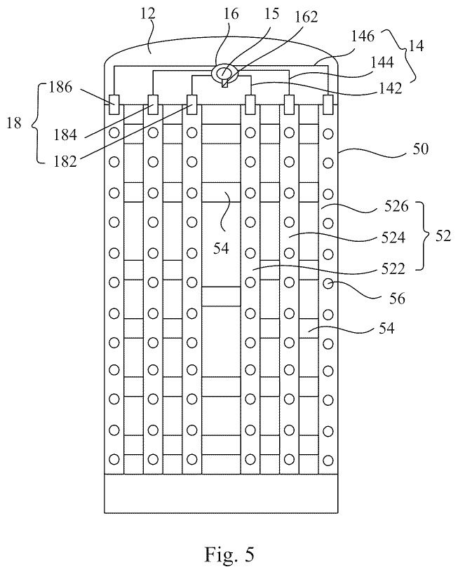

Please refer to FIG. 5. FIG. 5 is a schematic structural diagram of the air bubble massage met. In FIG. 5, the air bubble massage mat is composed of a cushion body 50 and a gas channel assembly 12, in which the cushion body 50 communicates with the gas channel assembly 12. The cushion body 50 includes a plurality of gas flow channels 52, each the plurality of gas flow channels 52 has a plurality of air holes 56. In this embodiment, there are also many ribs 54 provided between each the plurality of gas flow channels 52 to increase the supporting strength of the entire cushion body 50.

The gas channel assembly 12 includes a valve connection end 15, a plurality of gas channels 14 and a plurality of gas through holes 18, in which one end of each the plurality of gas channels 14 is connected to the valve connection end 15, another end of each the plurality of gas channels 14 is communicated with the plurality of gas through holes 18. Similarly, the plurality of gas channels 14 includes an inner-side gas channel 142, a middle gas channel 144, and an outer-side gas channel 146. The plurality of gas through holes 18 includes an inner-side gas through hole 182, a middle gas through hole 184, and an outer-side gas through hole 186. When the cushion body 50 is communicated with the gas channel assembly 12, the inner-side gas flow channel 522 of the cushion body 50 is communicated with the inner-side gas channel 142 through the inner-side gas channel 182, the middle gas flow channel 524 is communicated with the middle gas channel 144 through the middle gas through hole 184, and the outer-side gas flow channel 546 is communicated with the outer-side gas channel 146 through the outer-side gas through hole 186.

The control valve assembly 16 includes a regulator 162, one end of the control valve assembly 16 is connected to the valve connection end 15, another end of the control valve assembly 16 is connected to the air supply 22 through the delivery pipe 24. The regulator 162 is provided for controlling the air 222 delivered by the air supply 22 passes through the delivery pipe 24, the control valve assembly 16, the gas channel 14, the plurality of gas through holes 18 into the plurality of gas flow channels 52 of the cushion body 50, so the plurality of first bubbles (not shown) is generated through the plurality of air holes 56 of the plurality of gas flow channels 52.

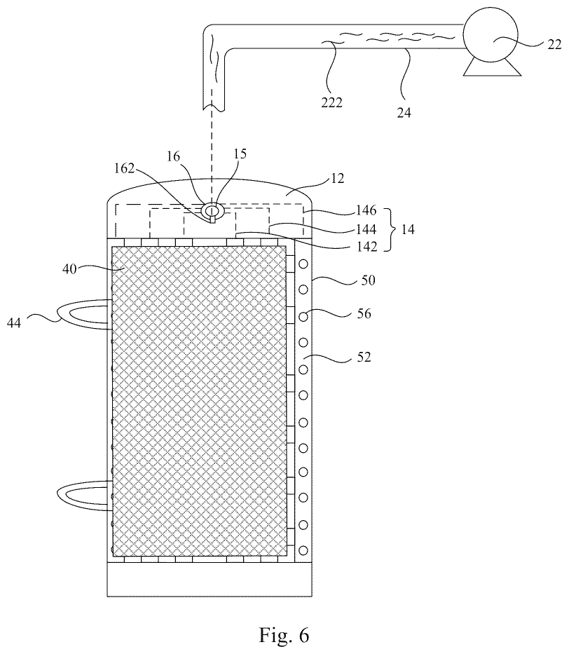

Next, please refer to FIG. 6. FIG. 6 is a schematic diagram showing another embodiment of an air bubble massage system. At the same time, please refer to FIG. 4 and FIG. 5. In FIG. 6, the cushion cover 40 in FIG. 4 is fixed on the cushion body 50 through the fixing strap 44 on the two sides of the cushion cover 40, so the gas flow channel 52 of the cushion body 50 can be covered by the cushion body 40 completely. In should be noted that in FIG. 6, parts of the gas flow channel 52 is exposed for convenience of description. Next, the air bubble massage mat includes the cushion cover 40, the cushion body 50, and the gas channel assembly 12 is connected to the air supply 22 through the delivery pipe 24, and the air bubble massage mat is placed in the massage bathtub (not shown) or bathtub (not shown), and the air bubble massage mat is fixed in the bathtub (not shown) through the suction device (not shown). After the user executes the air supply 22, the air 222 enters the control valve assembly 16 through the delivery pipe 24, user can control the position of the bubble generation through the regulator 162. When the regulator 162 is at the first position, the air 222 will pass through the inner-side gas channel 142 and the inner-side gas through hole 182 into the inner-side gas flow channel 522, the plurality of first bubbles (not shown) will be generated when air 222 is ejected through the plurality of air holes 56 of the inner-side gas flow channel 522. Then, when the plurality of first bubbles (not shown) passes through the mesh cloth of the cushion cover 40, the grids of the mesh cloth of the cushion cover 40 will cut the plurality of first bubbles (not shown) into a plurality of second bubbles (not shown), and the size of each the plurality of second bubbles (not shown) is smaller than that of the plurality of first bubbles (not shown), and the plurality of second bubbles (not shown) is provided for massaging the human body.

In another embodiment, when the user adjusts the regulator 162 at the second position, the air 222 will pass through the middle gas channel 144 into the middle gas through hole 182, so the air 222 will enter the middle gas flow channel 524. The plurality of first bubbles (not shown) is generated when the air 222 passes through the plurality of air holes 56 of the middle gas flow channel 524. Similarly, the plurality of first bubbles (not shown) passed through the mesh cloth of the cushion cover 40, the plurality of first bubbles is cut into a plurality of second bubbles (not shown) by the grids of the mesh cloth, and the size of each the plurality of second bubbles is smaller than that of each the plurality of first bubbles, thereby, the plurality of second bubbles is provided for massaging on the human body. In this embodiment, the bubble area generated by the inner-side gas flow channel 522 and the middle gas flow channel 524 is larger than that of the inner-side gas flow channel 522, while increasing the massage experience for user.

In a further embodiment, when the user adjusts the regulator 162 at the third position, the air 222 passes through the outer-side gas channel 146 and enters the outer-side gas through hole 186, so the air 222 enters the outer-side gas flow channel 526, the plurality of first bubbles (not shown) will be generated when the air 222 passes through the plurality of air holes 56 of the outer-side gas flow channel 526. Similarly, the plurality of first bubbles is cut into the plurality of second bubbles by the grids of the mesh cloth when the plurality of first bubbles (not shown) passed through the mesh cloth of the cushion cover 40, and the size of each the plurality of second bubbles is smaller than each that of most of the plurality of first bubbles (not shown), and the plurality of second bubbles (not shown) is provided for massaging the human body.

In another embodiment, when the user adjust the regulator 162 at the forth position, the air 222 will pass through the inner-side gas channel 142, the middle gas channel 144, and the outer-side gas channel 146 into the inner-side gas through hole 182, the middle gas through hole 184, and the outer-side gas through hole 186, the air 222 enter the inner-side gas flow channel 522, the middle gas flow channel 524, and the outer-side gas flow channel 526. The plurality of first bubbles (not shown) will be generated during the air 222 passed through the plurality of air holes 56 of the inner-side gas flow channel 522, the middle gas flow channel 524, and the outer-side gas flow channel 526. Similarly, the plurality of first bubbles (not shown) is cut into a plurality of second bubbles (not shown) when the plurality of first bubbles (not shown) passed through the grids of the mesh cloth of the cushion cover 40, and the size of each the plurality of second bubbles is smaller than each that of most of the plurality of first bubbles (not shown), and the plurality of second bubbles (not shown) is provided for massaging the human body. In this embodiment, the bubble area generated by the inner-side gas flow channel 522, the middle gas flow channel 524 and the outer-side gas flow channel 526 is the largest and the user's whole body can be massaged.

The advantage of fixing the cushion cover 40 on the cushion body 50 is that the cushion body 50 is hard material, the user will have uncomfortable feelings on the hard cushion body 50 whether the user is sitting or lying down. Moreover, the cushion body 50 is weight-resistant or pressure-resistant plastic material, and it will not have the conduction function or heat storage when placed in the warm water environment, so the user must always add hot water during bathing to maintain the water temperature in the bathtub (not shown) or massage bathtub (not shown). As mentioned above, the cushion cover 40 of this invention is placed in a warm water environment such as bathtub (not shown) or massage bathtub (no shown), and water temperature in the bathtub (not shown) or massage bathtub (not shown) can be evened out. The cushion cover 40 can retain the maximum body temperature in warm water environment and is capable of storing temperature, and can delay the local cooling rate of the parts in contact with the human body.

While the invention has been described in terms of what is presently considered to be the most practical and preferred embodiments, it is to be understood that the invention is not limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An air bubble massage mat, comprising:
a cushion cover, the cushion cover includes a top layer and a bottom layer, the top layer and the bottom layer are joined together to form an accommodation space therebetween, wherein the top layer and the bottom layer are a mesh cloth with grids respectively.

2. The air bubble massage mat according to claim 1, wherein the mesh cloth is a single layer or a multi-layer.

3. The air bubble massage mat according to claim 2, wherein the grids of adjacent layers in the multi-layer are interlaced with each other.

4. An air bubble massage system using the air bubble massage mat as described in claim 1, the air bubble massage system comprising:
the cushion cover, the cushion cover includes the top layer and the bottom layer, the top layer and the bottom layer are joined together to form the accommodation space therebetween, wherein the top layer and the bottom layer are a mesh cloth with grids respectively;
a gas channels assembly, the gas channel assembly is disposed in the accommodation space of the cushion cover, the gas channel assembly includes a valve connecting end, a plurality of gas channels and a plurality of gas through holes, wherein one end of the plurality of gas channels is connected to the valve connection end and another end of the plurality of gas channels is connected to the plurality of gas through holes;
a pipe assembly, the pipe assembly is connected to the gas channel assembly and disposed in the accommodation space of the cushion cover, the pipe assembly include a plurality of flexible tubes and a wall of each plurality of flexible tubes is provided with a plurality of blowholes, the plurality of blowholes is arranged below the top layer of the cushion cover; and
a control valve assembly, the control valve assembly includes a regulator, one end of the control valve assembly is connected to the valve connection end, and another end of the control valve assembly is connected to an air supply through a delivery pipe, the regulator is provided for controlling an air delivered by the air supply to enter each the plurality of flexible tubes through the delivery pipe, the control valve assembly, the plurality of gas channels and the plurality of gas through holes to generate a plurality of first bubbles through the plurality of blowholes on the wall of each the plurality of flexible tubes, and then the plurality of first bubbles is cut into a plurality of second bubbles through the grids of the top layer of the cushion cover, wherein the size of the plurality of first bubbles is larger than that of the plurality of second bubbles.

5. The air bubble massage system according to claim 4, wherein the size of each the plurality of blowholes is the same or different.

6. An air bubble massage mat, comprising:
a cushion cover, the cushion cover is a mesh cloth with grids, and two sides of the cushion cover have a fixing strap.

7. The air bubble massage mat according to claim 6, wherein the mesh cloth is a single layer or a multi-layer.

8. The air bubble massage mat according to claim 7, wherein the grids of adjacent layers in the single layer are interlaced with each other.

9. The air bubble massage mat according to claim 7, wherein the grids of adjacent layers in the multi-layer are interlaced with each other.

10. An air bubble massage system using the air bubble massage mat as described in claim 6, the air bubble massage system comprising:
a cushion body, the cushion body includes a plurality of gas fluid channels, and the plurality of gas fluid channels includes a plurality of air holes;
a gas channel assembly, the gas channels assembly is connected to the cushion body, the gas channel assembly includes a valve connection end, a plurality of gas channels and a plurality of gas through holes, wherein one end of the plurality of gas channels is connected to the valve connection end, another end of the plurality of gas channels is connected to the plurality of gas through holes, so the gas channel assembly is communicated with the cushion body through the plurality of gas through holes;
the cushion cover, the cushion cover is disposed on a top surface of the cushion body, the cushion cover is a mesh cloth with grids, and two sides of the cushion cover have a fixing strap, the cushion cover is provided for fixing on the cushion body through the fixing strap, so the mesh cloth with the grids is disposed above the plurality of air holes; and
a control valve assembly, the control valve assembly includes a regulator, and one end of the control valve assembly is connected to the valve connection end, another end of the control valve assembly is connected to an air supply through a delivery pipe, the regulator is provided for controlling an air delivered by the air supply to enter each the plurality of gas fluid channels of the cushion body through the delivery pipe, the control valve assembly, the plurality of gas fluid channels and the plurality of gas through holes to generate a plurality of first bubbles through the plurality of air holes on the plurality of gas fluid channels of the cushion body, and then the plurality of first bubbles is cut into a plurality of second bubbles through the grids of the cushion cover, wherein the size of the plurality of first bubbles is larger than that of the plurality of second bubbles.
